(19) United States
(12) Patent Application Publication
(10) Pub. No.: US 2024/0286735 A1
(43) Pub. Date: Aug. 29, 2024

(54) COLLECTIVE-PITCH ADJUSTMENT MECHANISM FOR VARIABLE-PITCH PROPELLER OR ROTOR UTILIZED IN A FLIGHT VEHICLE OR DRONE AND METHOD FOR SHAPING NOISE PROFILE

(71) Applicant: Toofon, Inc., El Segundo, CA (US)

(72) Inventors: Nathan SWEDLOVE, El Segundo, CA (US); Hubert WANG, El Segundo, CA (US); Michael V. OL, El Segundo, CA (US); Amir Emadi, El Segundo, CA (US); Morteza GHARIB, El Segundo, CA (US)

(73) Assignee: Toofon, Inc., El Segundo, CA (US)

(21) Appl. No.: 18/508,397

(22) Filed: Nov. 14, 2023

Related U.S. Application Data
(60) Provisional application No. 63/425,047, filed on Nov. 14, 2022.
(60) Provisional application No. 63/425,748, filed on Nov. 16, 2022.

(51) Int. Cl. B64C 11/44

(52) U.S. Cl. CPC B64C 11/44

(57) ABSTRACT

A collective pitch adjustment mechanism for a variable-pitch rotor that has blades for rotation about a rotor axis, e.g., for a flight vehicle or drone, via a motor. The mechanism has a servo actuator and a bearing cage for blade rotation. The servo actuator varies the collective pitch of the blades via a pushrod, and a servo actuator arm is configured for rotation and connected to the pushrod via a joint. Mounting portions are provided for securement of the blades and an actuation horn is coupled to the pushrod. The blades are rotationally and/or translationally coupled to the actuation horn via the mounting portions. The servo actuator causes rotational movement of the servo actuator arm, which in turn causes translational movement of the pushrod, which causes linear movement of the actuation horn to thereby collectively cause a collective change in a pitch angle, i.e. the collective pitch, of the blades.

### CROSS REFERENCE TO RELATED APPLICATION(S)

This application claims priority to U.S. Provisional Patent Application No. 63/425,047 entitled COLLECTIVE-PITCH ADJUSTMENT MECHANISM FOR VARIABLE-PITCH PROPELLER OR ROTOR UTILIZED IN A FLIGHT VEHICLE OR DRONE, filed Nov. 14, 2022, and U.S. Provisional Patent Application No. 63/425,748 entitled METHOD AND SYSTEM FOR SHAPING THE NOISE PROFILE OF A DRONE AND ITS ROTORS BY DYNAMICALLY ACTUATING PROPELLERS, filed Nov. 16, 2022, the contents of both of which are hereby incorporated in its entirety by this reference.

### BACKGROUND

### Field

The present disclosure is generally related to a mechanism for collectively adjusting a collective pitch of blades for a variable-pitch rotor or propeller. Such a mechanism may be used in a flight vehicle or drone.

### Description of Related Art

Flight vehicles sustained aloft by propellers or rotors tend to either have exclusively fixed-pitch rotors, or helicopter-style rotors. Single rotors may be utilized in flight vehicles. Coaxial rotors are pairs of rotors sharing a line of rotation, separated by some distance normal to the rotor planes. Drones or air-taxis typically employ a plurality of fixed pitch rotors, whether as individual rotors or coaxial pairs. Helicopters typically have a single rotor, a single coaxial pair, or a tandem pair of single rotors. In all cases, the rotors have variable cyclic and collective pitch, with a complex set of linkages and/or flexures. A third alternative, tilt-rotors, generally uses helicopter-style rotors with variable collective and cyclic pitch, with the associated complexity thereof. Examples of the prior art coaxial counter-rotating drone and helicopter are shown in FIGS. 1 (https://vulcanuav.com/aircraft/) and 2.

In all of these cases, either the rotors are fixed-pitch, precluding adjustment of blade angles for better aerodynamic efficiency or flight control; or they are all fully variable pitch for all blades, implying the complexity and weight of such systems.

Prior art have elucidated a VTOL vehicle topology consisting of the following:

A pair of counter-rotating horizontally opposed rotors, aligned approximately in the direction of flight of the aircraft, producing (a) horizontal propulsive force, (b) yaw control, (c) unbalanced vehicle yaw-torque cancellation.

A plurality of lifting rotors, aligned approximately opposing the direction of gravity, when the drone is in hover or horizontal flight, that produce the thrust to oppose the weight of the drone, together with moments in roll and pitch.

A flight controller that schedules the rotational speed of the aforementioned rotors, and also the collective-pitch blade angle of each respective rotor.

A system of wings and control surfaces on the wings, that is also addressed by the flight controller, blending the control-inputs of ailerons/elevators/rudders/flaps, with the control-inputs for each individual rotor rotational speed and collective pitch blade angle.

Helicopters routinely use variable pitch on their rotors. The main-rotor is almost always both variable collective and variable cyclic pitch. The latter introduces system elasticity, complexity and weight. These are essential when cyclic pitch is required for vehicle flight control; when it is not, the overhead of cyclic motion is undesirable. Meanwhile the classical helicopter tail rotor is strictly variable collective pitch, without cyclic motion. An example of a system at drone-scale is shown in FIGS. 3A and 3B. This approach has the detriments of a large, exposed linkages; limitation in blade angle travel before binding of the mechanism; an off-axis placement of the actuator (the servo and its motion-arm); and slop in the system due to panoply of joints. Importantly, there is a tall main-shaft on which the blade-grips are mounted. This length between the motor and the plane of the rotor blades can be a source of vibration at high rotational speeds or large loads at the blade grips (centripetal loads or thrust loads). FIGS. 3A and 3B show how servo pushrod position changes blade pitch angle from positive extreme (left) to negative extreme (right). The limitation in blade angle is contact between the yoke and the base for the 4-bar linkage (extreme positive) and between the yoke and blade grip assembly (extreme negative).

Another solution, evidently first suggested by Mark Cutler in a paper based on his MSE thesis (Cutler, M. N., Ure, N.-K., Michini, B., and How, J. P. “Comparison of Fixed and Variable Pitch Actuators for Agile Quadrotors”. AIAA 2011-6406), is to use a hollow-shaft motor, with a pushrod passing through the shaft, to below the motor, where there is a servo mechanism. This relies on a variation of the helicopter tail rotor mechanism to vary blade collective pitch.

A third approach is to adapt the constant-speed or variable pitch mechanism of piston-engined or turboprop fixed wing aircraft, first widely available in the 1930s and 1940s. There is a “bearing cage”, which moves the thrust bearings from the blade grips, as is common in the helicopter-style mechanism, to the inside of the cage. One example is shown in FIG. 4. In a fixed-wing application, variable pitch is used to tailor the performance of the propeller to a given flight condition of the airplane, such as climb, cruise or feather (set blades to minimum drag for an engine-out condition). Variable pitch is not used as a flight control device, and hence speed of pitch-change is not important. This allows for a gear-drive system for example, which is rigid and precisely actuated, but slow.

Further, existing drones/rotorcraft and flight vehicles have various noise profiles, but typically lack an approach toward controlling or limiting that noise. This is a problem particularly in urban air mobility, where noise can be disruptive to people. One example of a prior eVTOL/drone propeller noise-shaping or mitigating solution is attempted in WO2019232535A1. With multiple propellers, this '535 reference aims to spin some faster than others, to get favorable noise interferences. Further, with multiple blades per propeller in this '535 reference, the azimuthal spacing is also altered to reduce acoustic noise. Yet this reference (nor the prior art) does not provide both the ability to control blade pitch and noise mitigation/reduction.

### SUMMARY

It is an aspect of this disclosure to provide a collective pitch adjustment mechanism for a variable-pitch rotor that has a plurality of blades configured for rotation about a rotor axis. The mechanism has: a servo actuator for varying a collective pitch of the plurality of blades of said variable-pitch rotor via a pushrod, the servo actuator having a servo actuator arm that is configured for rotation and the servo actuator arm being connected to the pushrod via a joint to cause movement of the pushrod; and a bearing cage having mounting portions for securement of each blade thereto and an actuation horn rotationally coupled to the pushrod. Each of the plurality of blades is rotationally and/or translationally coupled to the actuation horn via the mounting portions (e.g., blade grips). For varying the collective pitch of the plurality of blades of each variable-pitch rotor, the servo actuator is configured to cause rotational movement of the servo actuator arm, which in turn is configured to cause translational movement of the pushrod via the joint, and the pushrod is configured to cause linear movement of the actuation horn to thereby collectively cause a collective change in a pitch angle of all of the blades.

Another aspect provides a flight vehicle including: a frame; a plurality of rotors mounted to the frame; and a drive motor for each respective rotor. Each of the rotors has a plurality of blades extending in a radial direction. The drive motor is provided for driving the rotor shaft about a rotor axis that extends in an axial direction. At least one of the plurality of rotors is a variable-pitch rotor. The vehicle also has a vehicle flight controller configured to initiate varying a collective pitch of the plurality of blades of each variable-pitch rotor. The vehicle further has a servo actuator and a bearing cage. The servo actuator allows for varying the collective pitch of the plurality of blades via a pushrod as a result of being initiated by the vehicle flight controller, and has a servo actuator arm that is configured for rotation, the servo actuator arm being connected to the pushrod via a joint to cause movement of the pushrod. The bearing cage is connected to the respective drive motor of each variable-pitch rotor, has mounting portions for securement of each blade thereto, and an actuation horn rotationally coupled to the pushrod. Each of the plurality of blades are rotationally and/or translationally coupled to the actuation horn via the mounting portions. To vary the collective pitch of the plurality of blades of each variable-pitch rotor, the servo actuator is configured to cause rotational movement of the servo actuator arm, which in turn is configured to cause translational movement of the pushrod via the joint, and the pushrod is configured to cause linear movement of the actuation horn to thereby collectively cause a collective change in a pitch angle of all of the blades.

Yet another aspect of this disclosure includes a method of controlling a collective pitch of blades in a variable pitch rotor, such as a rotor as noted above and described later below.

Other aspects, features, and advantages of the present disclosure will become apparent from the following detailed description, the accompanying drawings, and the appended claims.

### BRIEF DESCRIPTION OF THE DRAWINGS

FIG. 1 shows an example of a coaxial counter-rotating fixed pitch propeller multi-copter drone as known in the prior art.

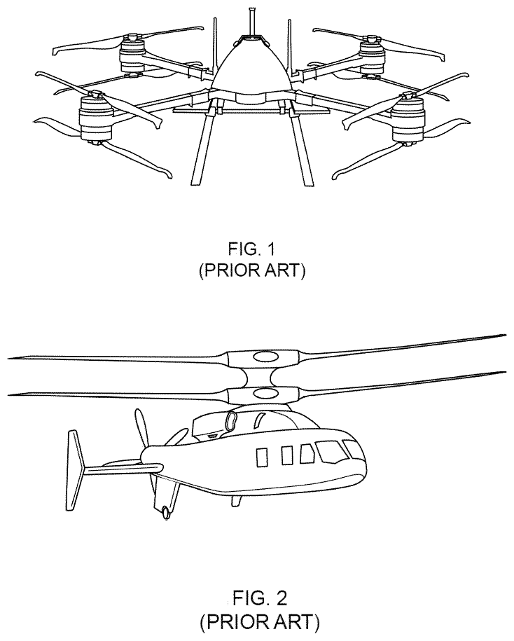

FIG. 2 shows a single-rotor helicopter with coaxial counter-rotating variable collective-cyclic rotors as known in the prior art.

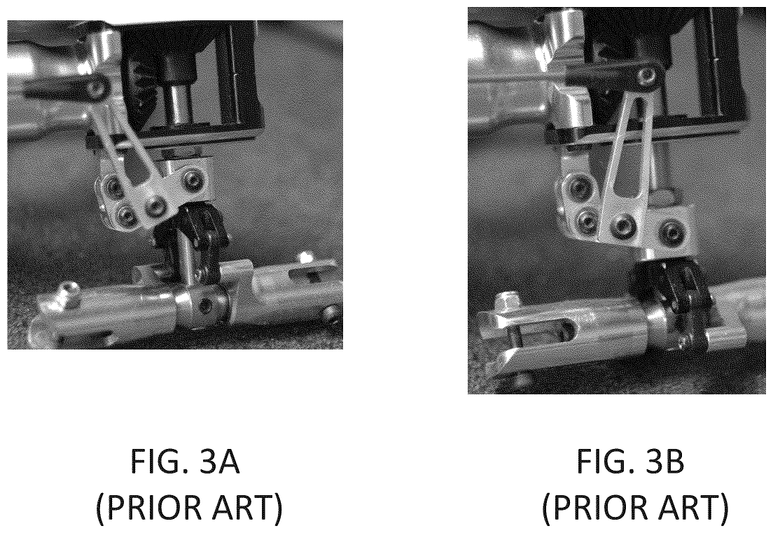

FIGS. 3A and 3B show a prior art example of a pushrod that is used to change a blade pitch angle from one extreme position to another extreme position.

FIG. 4 shows an example of a prior art bearing cage which moves mounting portions (e.g., blade grips) retained via thrust bearings inside of the cage.

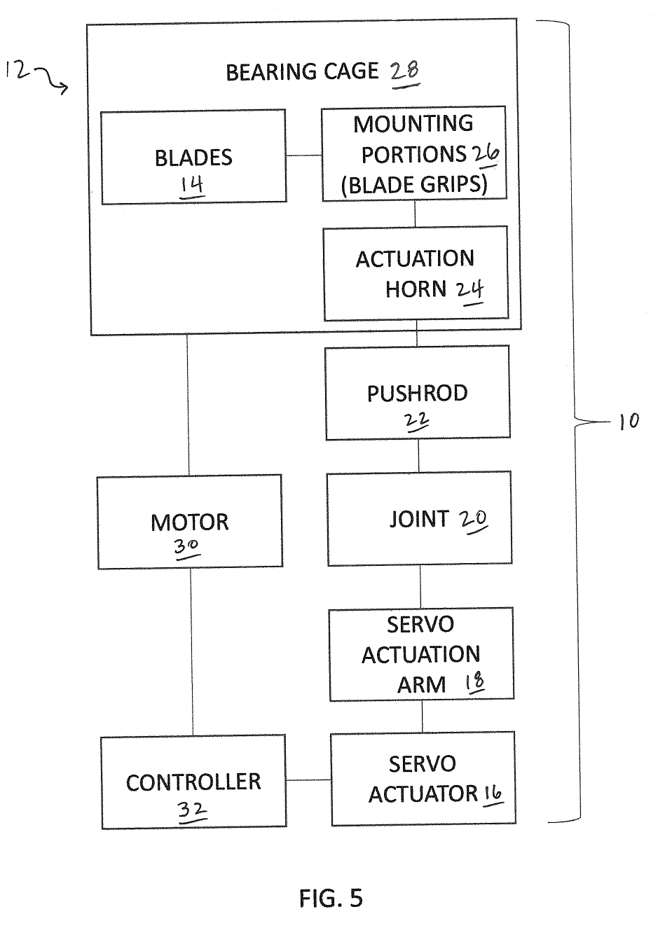

FIG. 5 shows a schematic block diagram of a collective pitch adjustment mechanism, for a variable-pitch rotor, in accordance with embodiments of this disclosure.

FIG. 6 illustrates an assembly of rotor blade hub assembly including a servo actuator, a servo actuator arm, sliding joint, drive motor, and a bearing cage in accordance with an embodiment of this disclosure.

FIG. 7 illustrates a detailed view of the sliding joint used with the servo actuator of FIG. 6 and a pushrod, in accordance with embodiments herein.

FIG. 8 illustrates an isometric view of the bearing cage of FIG. 6 with actuation horn and blade grips, in accordance with embodiments herein.

FIG. 9 illustrates a top view, with cover removed, of the parts of FIG. 8.

FIGS. 10 and 11 illustrate isometric and side views, respectively, of part of the bearing cage that holds thrust bearings, in accordance with embodiments herein.

FIG. 12 illustrates an isometric view of the actuation horn and mounting portions of the bearing cage, in accordance with embodiments herein.

FIG. 13 shows details of retention bolts and a bushing or bearing assembly for the mounting portions, in accordance with embodiments herein.

FIG. 14 shows a detailed view of a backside of a mounting portion, in accordance with embodiments herein.

FIG. 15 illustrates an assembly of rotor blade hub assembly including a servo actuator, a servo actuator arm, linkage joint, pushrod, and a bearing cage in accordance with another embodiment of this disclosure.

FIG. 16 illustrates a detailed view of the linkage joint used with the servo actuator and pushrod of FIG. 15, in accordance with embodiments herein.

FIG. 17 illustrates a detailed view parts of the linkage joint of FIG. 16.

FIG. 18 illustrates a detailed view of the connection of the pushrod to the actuation horn and mounting portions, in accordance with embodiments herein.

FIG. 19 illustrates an isometric view of the actuation horn and mounting portions of the bearing cage of FIG. 15, in accordance with embodiments herein.

FIG. 20 illustrates details of the actuation horn and mounting portions of FIG. 19.

FIG. 21A is an isometric view of an exemplary embodiment of a vehicle including a coaxial rotor pair assembly(ies) in accordance with embodiments herein.

FIG. 21B is a left-side view of the vehicle shown in FIG. 21A.

FIG. 22 is a schematic block diagram showing the relationship between parts of the vehicle and the coaxial rotor pair assembly as disclosed herein in accordance with embodiments.

### DETAILED DESCRIPTION OF THE PREFERRED EMBODIMENT(S)

As evident by the drawings and below description, this disclosure relates to a mechanism for producing variable collective pitch of a set of blades on each individual rotor, i.e., a collective pitch adjustment mechanism for a variable-pitch rotor. A variable collective pitch mechanism or system, such as that which is disclosed herein, needs to accomplish:

Suitable range of blade angle. For thrusters, which are the aircraft propulsive elements that produce the thrust approximately aligned with the direction of the aircraft travel, this means high positive angle for good thrust coefficient at high advance ratio, in fast cruise. It also means high negative blade angle to get negative thrust for maneuver at low speeds, such as to fly backwards, or to rapidly turn (yaw), where one thruster has positive thrust and the other negative, summing to net zero force but nonzero yawing torque. The blades should be cambered and twisted for good forward-flight efficiency. But because this results in high positive lift at zero root-angle (factory blade angle), to produce useful negative thrust, the negative blade angle range must also be large.

Mechanical strength. This means sustaining blade pull-out (centripetal) loads, blade lead-lag (in-plane) loads, root bending (blade thrust) loads, and the stressors of fatigue and vibration. Unlike fixed-wing-aircraft variable pitch mechanisms, for a VTOL aircraft the mechanism needs to be robust to loads in edgewise flight, which is to say, disparity in total speed magnitude between the advancing blade and the retreating blade. This is a time-varying load, changing once per revolution, for each blade.

Accommodating motion. This means a bearing-assembly to reduce friction for the mechanism that changes blade angle. The actuation mechanism, or pushrod(s), that connect the drive-system for blade angle change to the blade roots, must also operate smoothly.

Compactness and light weight. The in-plane size of the system should be small, to keep blade tip-to-tip diameter of a variable pitch propeller similar to that of a fixed pitch propeller of the same family, where the blades are the same off-of-the-shelf components.

Speed. One advantage of a variable collective pitch system is the rapidity with which an input at the controller becomes an output in change of force or torque at the rotor, and hence rapidly effecting a maneuver or correction at the aircraft. To achieve this, blade collective pitch angle should be changed quickly and precisely, with a minimum of lag, overshoot or oscillation.

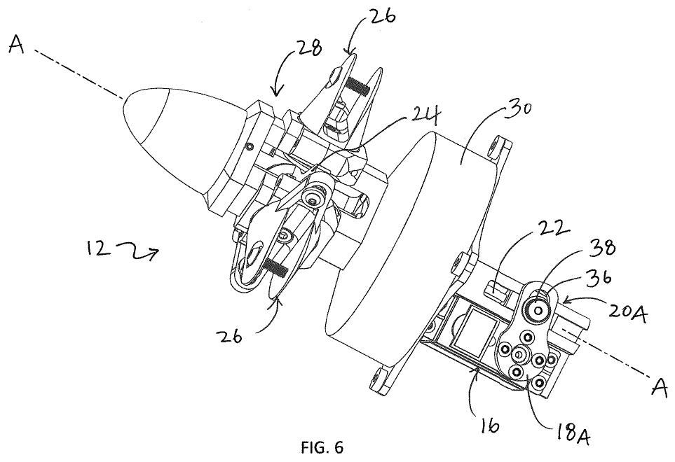

A collective pitch adjustment mechanism 10 for a variable-pitch rotor 12 that has a plurality or number of blades 14 configured for rotation about a rotor axis is disclosed herein in accordance with embodiments. FIG. 5 illustrates a schematic of parts of the collective pitch adjustment mechanism 20. The mechanism 10 has: a servo actuator 16 for varying a collective pitch of the plurality of blades 14 of said variable-pitch rotor 12 via a pushrod 22. The servo actuator 16 has a servo actuator arm 18 that is configured for rotation, and the servo actuator arm 18 is connected to the pushrod 22 via a joint 20 to cause movement of the pushrod 22. A bearing cage 28 has mounting portions 26 for securement of each blade 14 thereto, and an actuation horn 24 rotationally coupled to the pushrod 22. According to embodiments, the mounting portion 26 retains via one or more bolts, fasteners, or other means of attachment, each respective rotor blade, and/or may grip the blade. Hence it may be referred to herein, as a blade grip, in accordance with embodiments. However the term “blade grip” is not intended to be limiting in any way, i.e., while in some cases the mounting portions 26 may be designed to secure a root of each respective blade by providing gripping portions for grasping and securing the root of the blade therebetween, other forms of attachment may also be used to secure a blade in the bearing cage 28. Each of the blades 14 is rotationally and/or translationally coupled to the actuation horn 24 via the mounting portions 26 (e.g., blade grips). In order to vary the collective pitch of the blades 14 of each variable-pitch rotor 12, the servo actuator 16 is configured to cause rotational movement of the servo actuator arm 18, which in turn is configured to cause translational movement of the pushrod 22 via the joint 20. The pushrod 22 is configured to cause linear movement of the actuation horn 24 to thereby collectively cause a collective change in a pitch angle of all of the blades 14.

As understood by those skilled in the art, the blades 14 are set at a blade pitch (also referred to herein simply as “pitch”), i.e., an angle, with regards to a rotor shaft (not shown in FIG. 5) which is designed to rotate about a rotor axis A-A that extends in an axial direction. A drive motor 30 (e.g., electric motor) is typically associated with the rotor 12 for driving the respective rotor about the rotor axis A-A. The number of blades 14 extend in a radial direction. In the case of a variable-pitch rotor 12, the collective pitch of the blades 14 are configured to be collectively and selectively varied by a vehicle flight controller 32 (also referred to herein as simply a “controller”), i.e., during rotation. As generally understood by those of skill in the art, a “collective pitch” of the blades 22 refers to a blade angle at which all of the blades 14 are set or positioned in the variable-pitch rotor 12. As will be understood via this description, then, a blade pitch angle of each/all the blades 14 may be varied or changed between at least a first angle and a second angle, to vary the collective pitch of the variable-pitch rotor 12. That is, the angles or pitches of each/all of the blades 14 are changed collectively by rotating the blades substantially equally, resulting in a collective-pitch angle change at the propeller/rotor. In accordance with embodiments, then, the controller 32 is configured to selectively provide collective pitch control of the variable-pitch rotor 12, i.e., selectively vary or change a pitch angle of each of the blades 14 such that the blades 14 are all set at the same pitch, during rotation of the variable-pitch rotor about the rotor axis A-A, i.e., during flight of a vehicle.

For illustrative purposes only, the Figures show an exemplary, non-limiting embodiments wherein the rotor 12 includes three blades. However, it should be understood that the number of blades is not limited to three (3). In embodiments, the rotor 12 has an odd number of blades. In other embodiments, the rotor 12 has an even number of blades.

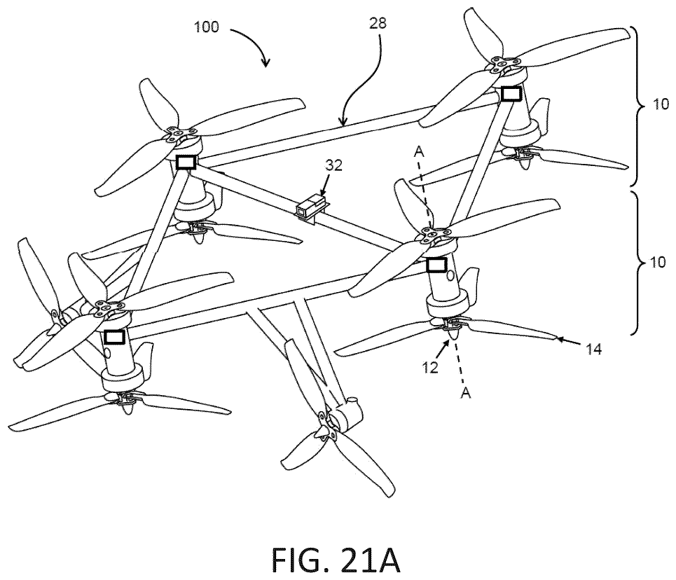

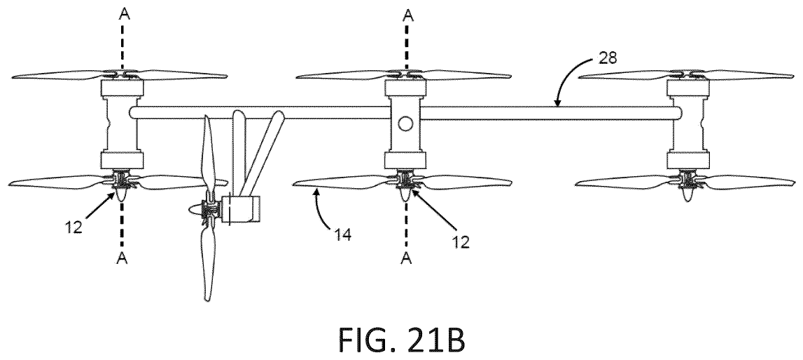

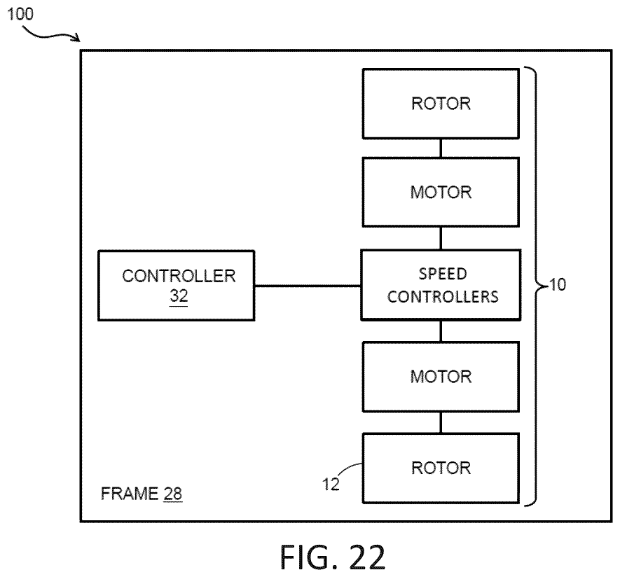

Accordingly, as generally discussed herein, it is within embodiments of this disclosure to provide a flight vehicle 100 with the herein described collective pitch adjustment mechanism 10. As noted in greater detail later (see, e.g., FIGS. 21A-21B and 22, such a flight vehicle may include a frame; a plurality of rotors mounted to the frame; and a drive motor. Each of the rotors has a drive motor is associated therewith for driving the rotor shaft about a rotor axis (A-A) that extends in an axial direction. At least one of the plurality of rotors is a variable-pitch rotor, like rotor 12, with motor 30. The vehicle flight controller 32 is configured to drive each motor and to initiate varying a collective pitch of the blades 14 of each variable-pitch rotor 12, as previously described (and also further described in detailed embodiments below). Specifically, as understood by one skilled in the art, the vehicle flight controller 32 is configured to send signals to electronic speed controllers associated with the motors of the blades, which in turn drives each motor, and separately, the vehicle flight controller 32 sends signals to one or more servomotors. Such details are not further described herein since they are generally understood to those in the industry. In embodiments, the vehicle has an even number of rotors, at least one rotor being a variable-pitch rotor 12. In other embodiments, vehicle has an odd number of rotors, at least one rotor being a variable-pitch rotor 12.

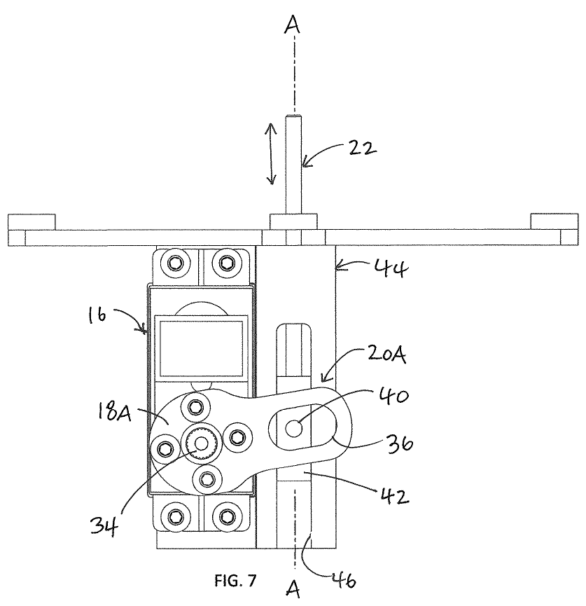

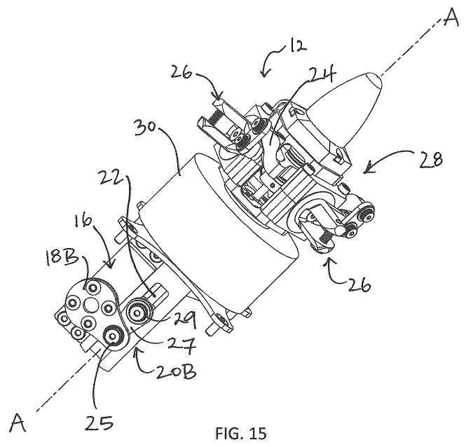

In accordance with embodiments, a conventional rotary servomotor may be used as the servo actuator 16. Typical rotational motion is over a 90-degree arc. At the mounting portions 26, the change in collective pitch angle is also a rotary motion. As noted previously, in this disclosure, the rotary motion at the servo actuator 16 is converted to translational or fore-aft motion of the pushrod 22. The servo actuator 16 is mounted relatively below the drive motor 30 that spins the rotor 12 (see, e.g., FIGS. 6 and 15 for examples of the relative mounting of a bearing cage 28, pushrod 22, drive motor 30, and servo actuator 16). The pushrod 22 passes through the (hollow) shaft of the motor 30 from the servo actuator 16. Above the motor 30 is the plane of rotation of the rotor 12; i.e., the rotor 12 is positioned relatively above the motor 30. Translational motion of the pushrod 22 is then converted back into rotational motion at the mounting portions 26, or blade grips. Thus, the passage of torque is from rotation at the servo shaft/actuator 16 via the servo actuator arm 18, converted into translation of the pushrod 22, and finally from translation of the pushrod 22 to rotation of the mounting portions 26.

Bearing cage 28 is designed to be secured or rigidly coupled (e.g., bolted) to a rotating part, i.e., a rotatable casing or case, of the drive motor 30, in one non-limiting embodiment. Accordingly, in such an embodiment, when the motor 30 rotates its casing, the bearing cage 28 [attached thereto] and thus blades 14 are rotated about axis A-A. A mounting portion 26 is provided for each blade; thus, in the illustrated embodiments, three blade grips or mounting portions 26 are shown (which again, are illustrative only and not intended to be limiting). In embodiments, the bearing cage 28 includes an odd number of mounting portions 26. In other embodiments, the bearing cage 28 includes an even number of mounting portions 26.

In embodiments, the mounting portions 26 or blade grips include pitch arms associated therewith. Mounting portions 26 are advantageously designed herein to cause motion, i.e., change the blade collective pitch angle, via the pitch arms, to cover across its range, which is nearly the full range of the servo-actuator 16. This allows for optimizing the combination of resolution of servo motion, speed and torque. To do this, a length of the servo actuator arm 18 has to be adjusted, and also that of the pitch-arm of each mounting portion 26. Further, as will be further illustrated by the embodiments and Figures described below, the actuation horn 24 includes a number of arms based on the number of blades. Specifically, the actuation horn 24 is a multi-arm single piece of material, e.g., metal, with a hole in its middle for receipt of the pushrod 22 therein. The pushrod 22 is designed to be “rotationally coupled”, so that the pushrod 22—which does not rotate—may move the actuation horn 24 linearly (i.e., up and down along axis A-A), but the actuation horn 24 itself rotates together with the bearing cage 28 about axis A-A.

More simply, movement of the pushrod 22 results in movement of the horn 24 which in turn results in alteration of the collective pitch angle of the blades 14, while rotation of the blades 14 about the axis A-A is initiated via driving the motor 30, its case, and rotation of the bearing cage 28.

The servo actuator arm 18 cannot be directly connected to the pushrod 22, because as the arm 18 rotates, i.e., also about axis A-A, the distance from the servo shaft to the pushrod 22 changes. To prevent bending the pushrod 22, some alternative is needed, i.e., joint 20. In this disclosure, two exemplary embodiments for connection are presented for joint 20, referred to herein as: a sliding joint 20A and a linkage joint 20B. Either may be implemented at the servo actuator arm 18 and pushrod 22. Further, in accordance with embodiments herein, either a similar sliding joint or a similar linkage joint may be implemented in the bearing cage 28, i.e., at or in the mounting portions 26.

### Sliding Joint

FIGS. 6-14 illustrate parts of a rotor blade hub assembly that utilizes sliding joints at both a servo end and rotor end thereof, in accordance with an embodiment. FIG. 6 illustrates a rotor blade hub assembly including servo actuator 16 and servo actuator arm 18A, which generally operates as previously described above with regards to arm 18, i.e., arm 18A is connected to the pushrod 22 to cause movement of the pushrod 22; specifically, servo actuator 16 is configured to cause rotational movement of the servo actuator arm 18A, which in turn is configured to cause translational movement of the pushrod 22. Also shown in FIG. 6 are sliding joint 20A, drive motor 30, and bearing cage 28 in accordance with an embodiment. Joint 20A connects servo actuator arm 18A to the pushrod 22 to cause its movement.

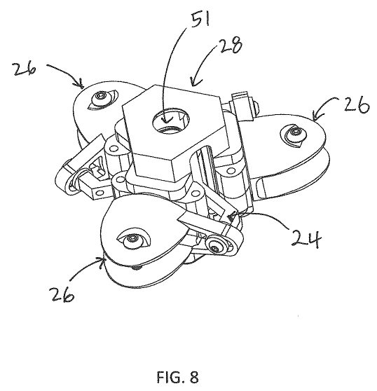

Details of the sliding joint 20A and servo actuator arm 18A are further shown in FIG. 7 (in addition to FIG. 6). Servo actuator arm 18A is connected at one end via a connector 34 (shown in FIG. 7) to a servo shaft of the servo actuator 16, such that rotation of the servo shaft causes movement of the arm 18A. The connector 34 may be a simple fastener, adapted to fit the particular servo, for example, in accordance with an embodiment. In accordance with embodiments herein, the servo actuator arm 18A has a slot 36 at its other end for connecting via sliding joint 20A to the pushrod 22. The slot 36 receives a securement device 38 (see FIG. 6) therein that is coupled to the pushrod 22. The securement device 38 may be a rotary bearing (removed in FIG. 7) that retains a shoulder bolt 40 (or other kind of bolt) within the slot 36, which is rigidly coupled to a block 42 affixed to a servo-end of the pushrod 22 for actuation of the actuation horn 24 at/near an opposite end thereof. Block 42 is provided in a housing 44 and is configured to move linearly with a housing slot 46 while also preventing rotation inside of the housing 44. As understood via FIG. 7, for example, a rotatable connection is thus provided between the block 42 of the pushrod 22 and servo actuator arm 18A, as the shoulder bolt/device 38 moves within the slot 36 as the arm 18A is moved. Accordingly, as the servo actuator arm 18A rotates via action of the servo actuator 16, the securement device 38 (bolt) moves linearly (e.g., up and down) with respect to a rotational or rotor axis A-A, and slides within the slot 36 of the servo actuator arm 18A, thereby causing the translational movement along axis A-A of the pushrod 22, without binding in the servo actuator arm 18A. Thus, rotation of the servo actuator arm 18A passes into translation of the pushrod 22.

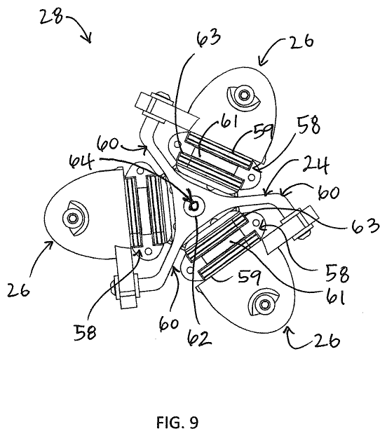

A similar approach is seen at the actuation horn 24, or other/actuation-end of the pushrod 22. Translation of the pushrod 22 along the axis of rotation A-A translates the actuation horn 24 relatively up or down, which in turn results in rotational motion (as a result of pitch arms) of the mounting portions 26 for the blades 14. An exemplary embodiment of the design of the actuation horn 24 and mounting portions 26 to implement a sliding motion to result in rotation or angular motion of the blades 14 via sliding joints is shown in FIGS. 8 to 14.

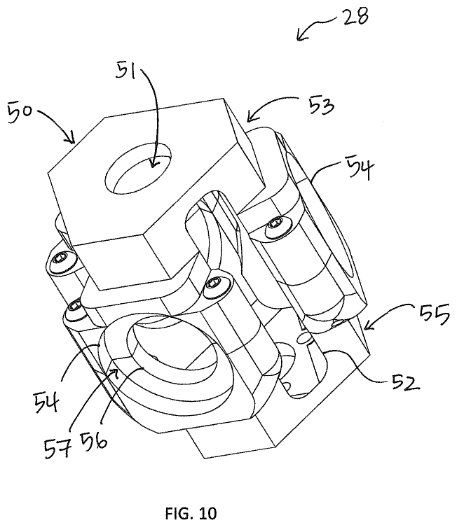

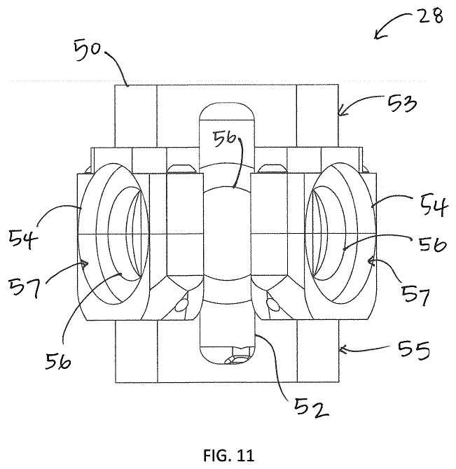

FIGS. 8 and 9 show an assembly of the bearing cage 28 with actuation horn 24 and mounting portions 26 or blade grips for the blades 14, in accordance with embodiments herein. The bearing cage 28 includes an upper shell 53 and a lower shell 55 that form a body 50, shown in FIGS. 10 and 11, which contains the actuation horn 24 and mounting portions 26, according to a non-limiting embodiment herein. While shells 53, 55 are shown as an example and provide manufacturing and assembly advantages which are evident herein, the body 50 need not be formed using, or limited to, upper and lower shells. Both the upper shell 53 and lower shell 55 of the body 50 include or form a central opening 51 or area extending axially therethrough, when assembled together, for containment of such parts (e.g., horn 24) therein. At least a portion of the actuation pushrod 22 that connects to the contained actuation horn 24 is also received in this opening or area. As shown in FIG. 8, for example, the actuation horn 24 is secured within the shells 53, 55 of the body and has its arms 60 extending outwardly therefrom. Specifically, pass-through openings or slots 52 (see FIGS. 10 and 11) are provided in the body 50 for arms 60 of the actuation horn 24 to extend there-through and to provide clearance in the bearing cage 28. A length of each slot 52 corresponds to maximum length of translational movement (as a result of the pushrod 22) for the actuation horn 24 within [the central opening 51 or area of] the bearing cage 28.

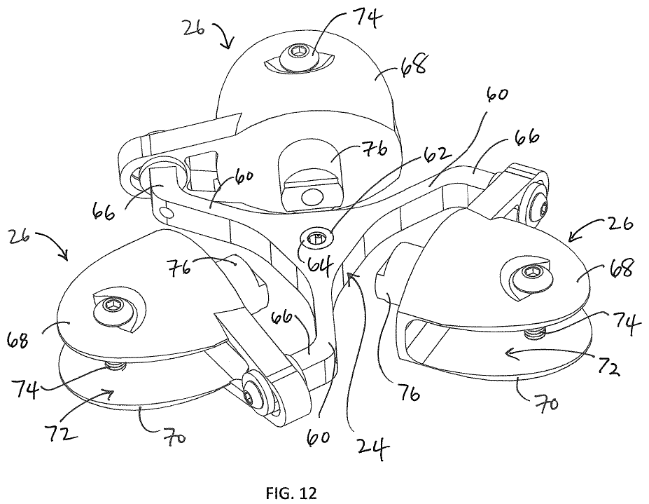

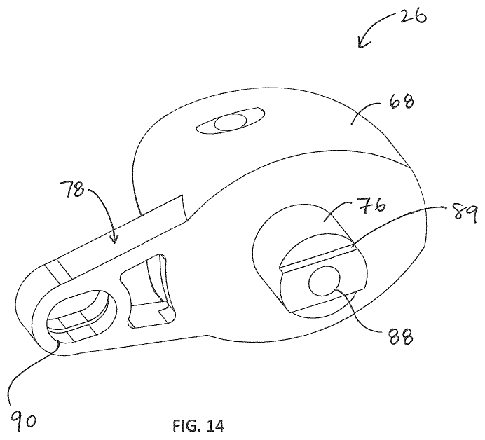

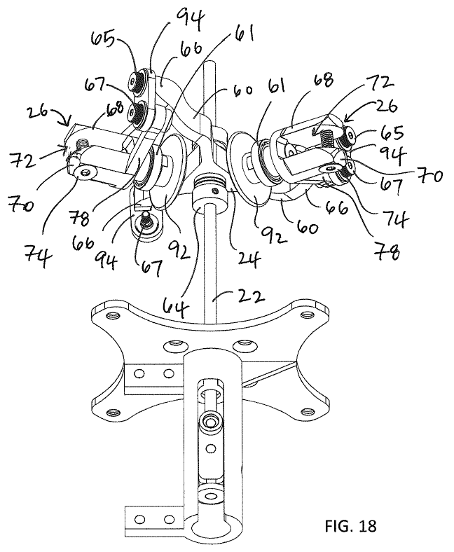

The body 50 also has receiving portions 54 for receipt of a part of bearing packages 58, shown in FIG. 9, for example. Each receiving portion 54 has a hole 56 therein, e.g., through a center portion thereof. In the exemplary illustrated embodiment, each bearing package 58 includes an outer thrust bearing assembly 59 (i.e., provided closer to the mounting portions 26), an inner thrust bearing assembly 63 (i.e., provided closer to a center of the bearing cage, or axis), and a roller bearing 61 provided therebetween. Accordingly, each hole 56 is configured to accommodate at its neck portion the roller bearing 61 of each bearing package 58, with outer bearing assembly 59 being provided in an adjacent, outer step or flat portion 57 (see FIG. 10) of the receiving portion 54, for example? Bearing packages 58 are contained on each blade grip/mounting portion 26 via a retention plate (not shown here, but similar to retention plate 92 as shown in FIG. 18) on a back side thereof. The thrust bearings 59, 63 react against centripetal loads of the blades 14 and blade grips 26, allowing for tightening of the respective retention bolt 84 through the blade grip 26, to the retention plate inside of the bearing cage 28. In particular, the roller bearing 61 reacts against the thrust loads on the blades, and allow for smooth change in blade collective pitch across the range of operating rpm and blade angle. Each of the holes 56 and/or receiving portions 54 may also accommodate at least a part of the mounting portions 26, which are shown and described with regards to FIGS. 12 and 14. The number of slots 52 and receiving portions 54 in the bearing cage 28/body 50 corresponds to the number of blades 14 provided on the rotor 12, in accordance with embodiments.

As better seen in FIG. 9 and FIG. 12, the actuation horn 24 includes a hole 62 in a central part thereof that receives a thrust bearing package 64 and the actuator-end (or rotor end) of the pushrod 22. The bearing package 64 at the actuation horn 24 tightly and rigidly connects the pushrod 22 to the actuation horn 24 for linear movement, while ensuring free rotatable connection between the pushrod 22 and actuation horn 24.

Each of the arms 60 of the actuation horn 24 may extend in a radial direction from the central part and include an angled portion 66 which is bent relative to the arm 60, according to some embodiments herein. However, such an angled configuration is exemplary only and not intended to be limiting.

Attached to the arms 60, via these angled portions 66, are the mounting portions 26, or blade grips, for the blades 14. In embodiments, as briefly noted, the mounting portions 26 may be provided in the form of blade grips to secure a root of each respective blade 14 therebetween and secure said blade centripetally with regards to the bearing cage 28. In an embodiment, each blade grip 26 includes first and second plates 68, 70 (e.g., top and bottom plates), respectively, such as shown in FIG. 12, that extend substantially parallel to one another and are spaced a distance from one another, such that there is a receiving slot 72 for the blade 14. The distance between the plates 68, 70 (or of the receiving slot 72) is based on a thickness of the blade received therein. A root of each blade 14 is configured to be inserted into the receiving slot 72 such that it is flanked by the plates 68, 70, and a retaining bolt 74 is inserted through an opening in at least one of the plates 68 or 70 and through an opening in the root of the blade 14 for securing the blade therein.

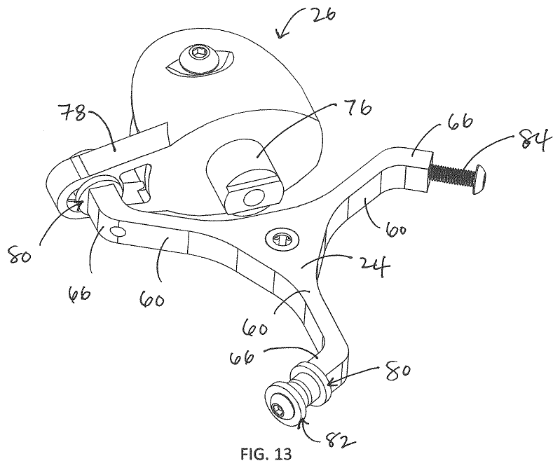

Adjustment of the collective pitch of the blades may be triggered via sliding motion or a sliding joint that is part of the blade grips 26, in accordance with embodiments herein. In embodiments, each blade grip 26 has a shaft or stem 76 pointing inwards towards the rotor axis A-A of rotation for connection to the bearing cage 28 via rotary and thrust bearing packages 58, and a pitch arm 78 extending away from a longitudinal axis of the blade 14. Such features are shown in detail in FIGS. 13 and 14. The stem 76 may be a cylindrical stem in accordance with embodiments, and is designed for rotation for variable pitch. The stem 76 is circumscribed by the roller bearing 61 and is gripped inside of the respective flat of the bearing cage 28 using a retention bolt 84 (shown in FIG. 13) which extends through thrust bearings 59, 63 and roller bearing 61 to the retention plate associated therewith. To simplify assembly, the stem 76 has a slot 88 (see FIG. 14) for receipt of an end of the retention bolt 84 and a groove 89 (formed on either side of the slot 88) that is designed to fit into a corresponding slot (not shown) of the aforementioned retention plate. The pitch arm 78 is rotationally and/or translationally coupled to the actuation horn 24 via a bushing assembly 80 (see FIG. 13), or bearing assembly. More specifically, each of the pitch arms 78 includes a slot 90 (see FIG. 14) for receipt of the bushing or bearing assembly 80. Each bushing or bearing assembly 80 includes a bushing 82 mounted via a retention bolt 84 secured in the angled portions 66 of the arms 60 of the actuation horn 24. The bushing 82 of the bushing assembly 80 is configured to slide within the slot 90, for the change in blade angle or pitch upon actuation of the actuation horn 24. Since each of the pitch arms 78 are rigidly fitted to the actuation horn 24, as the actuation horn translates up or down, a rotational motion of each pitch arm 78 is affected. Because each pitch arm 78 is equally coupled to the actuation horn 24, each pitch arm 78 rotates an amount equal to that of any other pitch arm, resulting in a collective-pitch angle change at the propeller.

### Linkage-Joint

FIGS. 15-20 illustrate parts of a rotor blade hub assembly that utilizes linkage joints at both a servo end and rotor end thereof, in accordance with another embodiment. In this embodiment, there are no sliding connections, and hence the friction or potential binding of sliding-connections is obviated. FIG. 15 illustrates an assembly of rotor blade hub assembly including servo actuator 16 and servo actuator arm 18B, which generally operates as previously described above with regards to arm 18, i.e., arm 18B is connected to the pushrod 22 to cause movement of the pushrod 22; specifically, servo actuator 16 is configured to cause rotational movement of the servo actuator arm 18B, which in turn is configured to cause translational movement of the pushrod 22. Also shown in FIG. 15 are linkage joint 20B, drive motor 30, and bearing cage 28 in accordance with an embodiment. Joint 20B connects servo actuator arm 18B to an intermediate servo arm 27, which is connected to another rotatable joint or connector 29, and thence to the pushrod 22 to cause its movement.

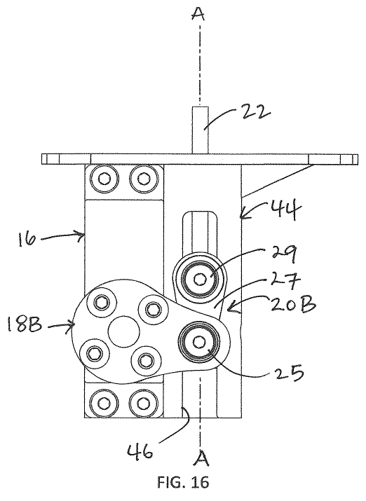

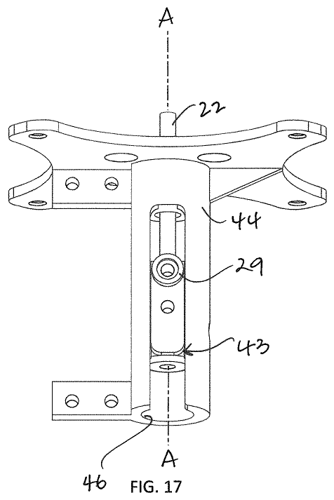

Details of the linkage joint 20B and servo actuator arm 18B are further shown in FIGS. 16 and 17 (in addition to FIG. 15). Servo actuator arm 18B is connected at one end via a connector (not shown) to a servo shaft of the servo actuator 16, such that rotation of the servo shaft causes rotational movement of the arm 18B. In accordance with embodiments herein, the servo actuator arm 18B is connected using a rotatable connector 25 at its other end to a first end of a link or intermediate servo arm 27, thereby forming the linkage joint 20B. Intermediate servo arm 27 is connected at a second end thereof via a second rotatable connector 29 which is connected to the pushrod 22. More specifically, rotatable connector 29 is rotatably coupled to a block 43 affixed to a servo-end of the pushrod 22 for actuation of the actuation horn 24 at/near an opposite end thereof. Each rotatable connector 25 and 29 may be a rotary bearing that retains a shoulder bolt (or other kind of bolt). Block 43 is provided in housing 44 and is configured to move linearly with housing slot 46 while also preventing rotation inside of the housing 44. As understood via FIG. 16 and FIG. 17, for example, a rotatable connection (or linkage joint) is thus provided between intermediate servo arm 27 and the block 43 of the pushrod 22 via servo actuator arm 18B movement. Accordingly, as the servo actuator arm 18B rotates via action of the servo actuator 16, the intermediate servo arm 27 is rotated at rotatable connectors 25 and 29, which in turn causes pushrod 22 to move linearly (e.g., up and down) with respect to a rotational or rotor axis A-A, thereby causing the translational movement along axis A-A of the pushrod 22, without binding in the servo actuator arm 18B or arm 27. Thus, rotation of the servo actuator arm 18B passes into translation of the pushrod 22 via intermediate servo arm 27.

A similar approach is seen at the actuation horn 24, or other/actuation-end of the pushrod 22, as described previously. An exemplary embodiment of the design of the actuation horn 24 and mounting portions 26 (or blade grips) to implement motion to result in rotation or angular motion of the blades 14 via linkage joints is shown in FIGS. 18 to 20.

Although not shown with respect to this embodiment, it should be understood that the bearing cage 28 includes a body 50 having an upper shell 53 and a lower shell 55 with the actuation horn 24 provided in body 50 so that its arms 60 extend outwardly through openings or slots 52 provided within the body 50/upper shell and lower shell as previously disclosed above and described, for example, with reference to FIGS. 10 to 11. Similarly, the actuation horn 24 includes hole 62 and a thrust bearing package 64 and radial arms 60 with an angled portion 66 for attachment of the mounting portions/blade grips 26 for the blades 14. Blade grips 26 include first and second plates 68, 70 (e.g., top and bottom plates), stems 76 are provided thereon, as well as thrust bearing packages 58 and pitch arms 78, as previously discussed. For purposes of clarity and brevity, like elements and components throughout the Figures are labeled with same designations and numbering as discussed with reference to FIGS. 5-14. Thus, although not discussed entirely in detail herein, one of ordinary skill in the art should understand that various features of FIGS. 15-20 are similar to those features previously discussed. Additionally, it should be understood that the features shown in each of the individual figures is not meant to be limited solely to the illustrated embodiments. That is, the features described throughout this disclosure may be interchanged and/or used with other embodiments than those they are shown and/or described with reference to.

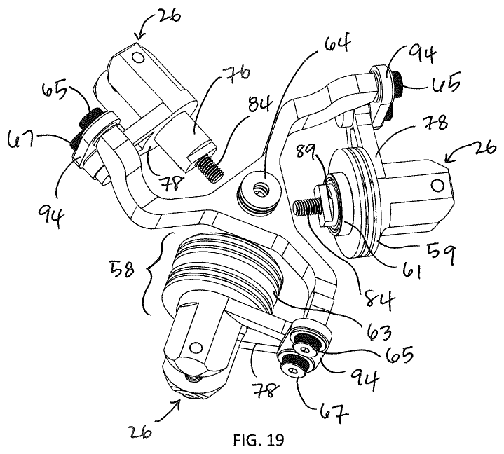

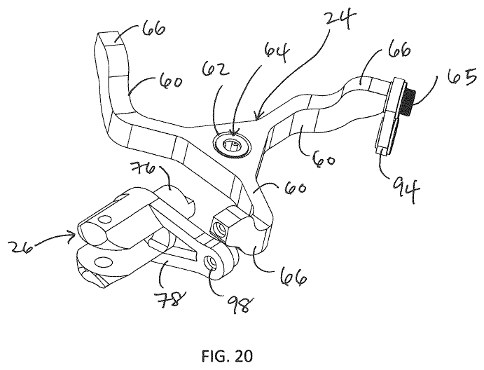

According to the embodiment shown in FIGS. 18-20, adjustment of the collective pitch of the blades may be triggered via a linkage joint in the form of an intermediate linkage arm 94 that is rotatably coupled to the blade grips 26. More specifically, a collective change in a pitch angle of all of the blades is implemented by converting via the intermediate linkage arms, linear movement of the actuation horn to rotational movement of the mounting portions/blade grips 26. In embodiments, stem 76 points inwards towards the rotor axis A-A of rotation for connection to the bearing cage 28 via rotary and thrust bearing packages 58 and the pitch arm 78 of each blade grip 26 extends away from a longitudinal axis of the blade 14. The pitch arm 78 is rotationally and/or translationally coupled to the actuation horn 24 via intermediate linkage arm 94, as seen in FIG. 18 and FIG. 19. Each intermediate linkage arm 94 includes a first opening at a first end thereof for receipt of a shoulder bolt 65 therethrough for connection to the angled portions 66 of the arms 60 of the actuation horn 24, via a rotary bearing like roller bearing 61. That is, bearing packages 58 (as previously described above) may be utilized with this design as well. Such bearing packages 58 (see FIG. 19) are contained on each blade grip/mounting portion 26 via a retention plate 92 (seen in FIG. 18) on a back side thereof. The thrust bearings 59, 63 react against centripetal loads of the blades 14 and blade grips 26, allowing for tightening of the respective retention bolt 84 through the blade grip 26, to the retention plate 92 inside of the bearing cage 28. A second opening is provided at a second end of the intermediate linkage arm 94 for receipt of a second bolt 67 therethrough, which connects through an opening 98 (see FIG. 20) in the pitch arm 78 (see FIG. 18, showing securement of bolt 67 to pitch arm 78). As the actuation horn 24 moves up and down, or in other words axially along the axis A-A of the pushrod 22, the shoulder bolt 65 moves up and down accordingly. This causes the intermediate linkage arm 94 at the shoulder bolt 65 to move up and down accordingly, while at the securement bolt 67, on the opposite end of the intermediate linkage arm 94, there is a combination of up and down motion, parallel to the axis of the pushrod 22, and a rotational motion, about the shoulder bolt 65. The motion at the securement bolt 67 passes to the pitch arm 78, resulting in a rotation of the pitch arm 78 within its respective roller bearing. Accordingly, the intermediate linkage arms are configured to convert said linear movement to rotational movement of the mounting portions 26. This is what changes the blade collective pitch angle.

While the above examples of the sliding joint and linkage joint have been described and shown as using each of said joints at both the servo end and the rotor ends of the pushrod 22, it should be noted that, in accordance with embodiments herein, it is envisioned that a rotor blade hub assembly may use a combination of such joints therein. For example, it is possible to use the linkage-joint at the servo arm, but a sliding joint at the actuation horn; or vice versa; or sliding joints at both, or linkage joints at both.

Accordingly, as generally discussed herein, it is within embodiments of this disclosure to provide a flight vehicle with the herein described collective pitch adjustment mechanism 10. In embodiments, the collective pitch adjustment mechanism 10 may be part of a multiple coaxial rotor pair assembly, i.e., a fixed-pitch rotor and a variable-pitch rotor. In an embodiment, the collective pitch adjustment mechanism may be used as part of an assembly as described in U.S. Provisional Patent App. No. 63/425,133, filed on the same day as this application, entitled, “Coaxial Rotor Pair Assembly with Variable Collective Pitch Rotor/Propeller for Flight Vehicle or Drone”. Generally, as represented in FIGS. 21A and 21B and the schematic of FIG. 22, a flight vehicle 100 may include a frame and a plurality of rotors mounted to the frame. In embodiments, at least two of said rotors are designed to form a coaxial rotor pair assembly 10, with the variable-pitch rotor of said assembly including a collective pitch adjustment mechanism 10 as described in embodiments herein. Each coaxial rotor pair 10 comprises a fixed-pitch rotor and a variable-pitch rotor 12 that are axially spaced relative to one another on the respective rotor axis A-A (see FIG. 21B) and axially aligned along said respective rotor axis A-A for rotation via a respective rotor shaft extending along the rotor axis. A motor is provided for each rotor, and the controller 32 is mounted on its frame 28 (see FIG. 21A). Controller 32 is further configured to selectively vary a collective pitch of each of the plurality blades 14 of the variable-pitch rotor 12 during rotation, i.e., during flight.

In another embodiment, at least some of the rotors on a flight vehicle 100 are variable-pitch rotors 12 that utilize a collective pitch adjustment mechanism 10. In still another embodiment, a variable-pitch rotor may be part of a coaxial rotor pair, wherein one or both of the rotors in the pair is variable and utilizes the collective pitch adjustment mechanism 10; any number of coaxial rotor pairs (including at least one variable-pitch rotor that utilizes a collective pitch adjustment mechanism 10) may be provided in a flight vehicle 100. In yet another embodiment, all of the rotors on a flight vehicle 100 are variable-pitch rotors 12 that utilize a collective pitch adjustment mechanism 10.

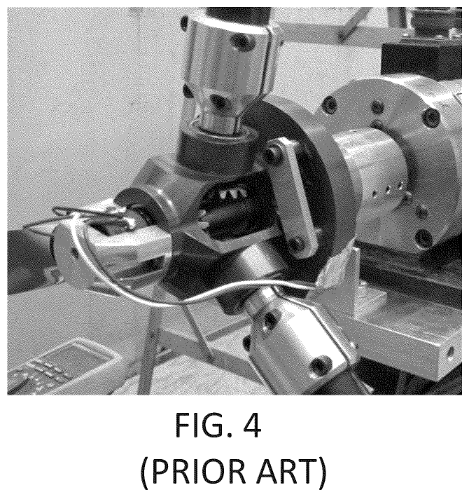

The rotors provided on the flight vehicle 100 may or may not be a part of a coaxial rotor pair assembly 10. The number of coaxial pair assemblies 10 provided on vehicle 100 is also not limiting. In an embodiment, the vehicle 100 has an even number of coaxial rotor pairs. In another embodiment, the vehicle 100 has an odd number of coaxial rotor pairs. Further, the rotors on vehicle 100 need not be part of a pair. That is, additional rotors or rotor pairs may be provided on vehicle 100. For example, as shown in the exemplary, non-limiting embodiments of FIGS. 3A-3B, an aircraft, drone, or vehicle 100 includes a total of eight lifting rotors that are part of four coaxial pairs 10 and two horizontal thrusters 32, i.e., rotors that are horizontally or perpendicularly mounted (relative to the rotor axis A-A) on frame 28 using arms extending from a base of the frame 28.

Controller 32 is configured to selectively vary or change a pitch angle of each of the blades 14 such that the blades 14 are all set at the same pitch, during rotation of the variable-pitch rotor about the rotor axis A-A, i.e., during flight of a vehicle, as noted. The controller 32 may include one or more processors and one or more sensors to measure and record the rotor and/or vehicle state, which includes speeds, positions in space, linear and angular accelerations and rates, etc., for example. Further, controller 32 includes both hardware and software associated therewith; e.g., hardware to process sensor data and to control the vehicle 100, and software to run on the hardware, e.g., to issue commands to a variable-pitch rotor 12.

As a result, the controller 32 (and its processors, sensors, etc.) may be used to implement a method for controlling the disclosed mechanism 10, using the steps and mechanisms described throughout this disclosure.

Moreover, because the controller 32 enables varying of pitch of the blades, the disclosed design herein also provides a method and system that enables shaping of the noise profile of the vehicle 100 and its rotors by dynamically actuating its propellers during flight. In an embodiment, the controller 32 is configured to increase pitch angle of the blades 14, allowing for lower rpm, at the same thrust-level, and hence less noise, if blade diameter is constant. In another embodiment, the blade count (solidity) may be increased, from 2 blades to 3, or 3 blades to 4, wherein because of the higher solidity, the same amount of thrust is available at a lower rpm. This is a means of reducing rpm while keeping the rotor diameter constant, resulting in lower blade tip-speed, and hence less noise. With variable collective pitch, rpm does not have to be increased for higher payloads, as instead, the blade pitch is increased, instead of the rpm. This allows for maintaining lower decibel (db) levels at variable payloads, since one is able to trade off slightly worse efficiency for better noise profiles.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A collective pitch adjustment mechanism for a variable-pitch rotor, the variable pitch rotor comprising a plurality of blades configured for rotation about a rotor axis, said mechanism comprising:
a servo actuator for varying a collective pitch of the plurality of blades of said variable-pitch rotor via a pushrod, the servo actuator comprising a servo actuator arm that is configured for rotation and the servo actuator arm being connected to the pushrod via a joint to cause movement of the pushrod;
a bearing cage comprising mounting portions for securement of each blade thereto and an actuation horn rotationally coupled to the pushrod, each of the plurality of blades being rotationally and/or translationally coupled to the actuation horn via the mounting portions;
wherein, for varying the collective pitch of the plurality of blades of each variable-pitch rotor, the servo actuator is configured to cause rotational movement of the servo actuator arm, which in turn is configured to cause translational movement of the pushrod via the joint, and the pushrod is configured to cause linear movement of the actuation horn to thereby collectively cause a collective change in a pitch angle of all of the plurality of blades.

2. The mechanism according to claim 1, wherein the servo actuator arm comprises a slot that receives a securement device that is coupled to the pushrod, such that, as the servo actuator arm rotates via action of the servo actuator, the securement device moves linearly with respect to the rotor axis of the variable-pitch rotor and slides within the slot of the servo actuator arm, thereby causing the translational movement of the pushrod, without binding in the servo actuator arm.

3. The mechanism according to claim 1, further comprising an intermediate servo arm that is rotationally connected to the servo actuator arm at a first end and rotationally coupled to the pushrod at a second end thereof, such that, as the servo actuator arm rotates, the intermediate servo arm is configured to rotate at each of the first end and the second end, thereby causing the translational movement of the pushrod.

4. The mechanism according to claim 1, wherein the mounting portions are provided in the form of blade grips that secure a root of each respective blade therebetween and centripetally with regards to the bearing cage.

5. The mechanism according to claim 4, wherein each blade grip comprises a stem pointing inwards towards the rotor axis of rotation for connection to the bearing cage via rotary and thrust bearings, and a pitch arm extending away from a longitudinal axis of the respective blade, wherein the pitch arm is rotationally and/or translationally coupled to the actuation horn via a bushing or bearing assembly.

6. The mechanism according to claim 5, wherein each pitch arm comprises a slot for receipt and movement of the bushing or bearing assembly therein, such that movement of the bushing or bearing assemblies within the slots of the pitch arms within the blade grips causes the collective change in the pitch angle of all of the plurality of blades.

7. The mechanism according to claim 1, further comprising an intermediate linkage arm between the mounting portions and the actuation horn, wherein the pushrod is configured to cause linear movement of the actuation horn and wherein said linear movement results in a collective change in a pitch angle of all of the plurality of blades, by converting via the intermediate linkage arms, said linear movement to rotational movement of the mounting portions.

8. The mechanism according to claim 1, wherein the bearing cage includes an odd number of mounting portions.

9. The mechanism according to claim 1, wherein the bearing cage includes an even number of mounting portions.

10. A flight vehicle comprising:
a frame;
a plurality of rotors mounted to the frame, each of the plurality of rotors comprising a plurality of blades extending in a radial direction;
a drive motor associated with each rotor for driving a respective rotor shaft about a rotor axis that extends in an axial direction;
at least one of the plurality of rotors comprising a variable-pitch rotor;
a controller configured to drive each motor and to initiate varying a collective pitch of the plurality of blades of each variable-pitch rotor;
a servo actuator for varying the collective pitch of the plurality of blades via a pushrod as a result of being initiated by the controller, the servo actuator comprising a servo actuator arm that is configured for rotation and the servo actuator arm being connected to the pushrod via a joint to cause movement of the pushrod;
a bearing cage connected to the respective drive motor of each variable-pitch rotor, the bearing cage comprising mounting portions for securement of each blade thereto and an actuation horn rotationally coupled to the pushrod, each of the plurality of blades being rotationally and/or translationally coupled to the actuation horn via the mounting portions;
wherein, for varying the collective pitch of the plurality of blades of each variable-pitch rotor, the servo actuator is configured to cause rotational movement of the servo actuator arm, which in turn is configured to cause translational movement of the pushrod via the joint, and the pushrod is configured to cause linear movement of the actuation horn to thereby collectively cause a collective change in a pitch angle of all of the plurality of blades.

11. The vehicle according to claim 10, wherein the servo actuator arm comprises a slot that receives a securement device that is coupled to the pushrod, such that, as the servo actuator arm rotates via action of the servo actuator, the securement device moves linearly with respect to the rotor axis of each variable-pitch rotor, and slides within the slot of the servo actuator arm, thereby causing the translational movement of the pushrod, without binding in the servo actuator arm.

12. The vehicle according to claim 10, further comprising an intermediate servo arm that is rotationally connected to the servo actuator arm at a first end and rotationally coupled to the pushrod at a second end thereof, such that, as the servo actuator arm rotates, the intermediate servo arm is configured to rotate at each of the first end and the second end, thereby causing the translational movement of the pushrod.

13. The vehicle according to claim 10, wherein the servo actuator is positioned relatively below the drive motor, the pushrod passes through the drive motor from the servo actuator, and the variable-pitch rotor is positioned relatively above the drive motor.

14. The vehicle according to claim 13, wherein the bearing cage is rigidly coupled to the drive motor.

15. The vehicle according to claim 10, wherein the mounting portions are provided in the form of blade grips that secure a root of each respective blade therebetween and centripetally with regards to the bearing cage.

16. The vehicle according to claim 15, wherein each blade grip comprises a stem pointing inwards towards the rotor axis of rotation for connection to the bearing cage via rotary and thrust bearings, and a pitch arm extending away from a longitudinal axis of the respective blade, wherein the pitch arm is rotationally and/or translationally coupled to the actuation horn via a bushing or bearing assembly.

17. The vehicle according to claim 16, wherein each pitch arm comprises a slot for receipt and movement of the bushing or bearing assembly therein, such that movement of the bushing or bearing assemblies within the slots of the pitch arms within the blade grips causes the collective change in the pitch angle of all of the plurality of blades.

18. The vehicle according to claim 10, further comprising an intermediate linkage arm between the blades and the actuation horn, wherein the pushrod is configured to cause linear movement of the actuation horn and wherein said linear movement results in a collective change in a pitch angle of all of the plurality of blades, by converting via the intermediate linkage arms, said linear movement to rotational movement of the mounting portions.

19. The vehicle according to claim 10, wherein the variable-pitch rotor has an odd number of blades and the bearing cage includes an odd number of mounting portions.

20. The vehicle according to claim 10, wherein the variable-pitch rotor has an even number of blades and the bearing cage includes an even number of mounting portions.

21. The vehicle according to claim 10, wherein the vehicle comprises an even number of rotors.

22. The vehicle according to claim 10, wherein the vehicle comprises an odd number of rotors.

23. The vehicle according to claim 10, wherein the plurality of rotors of the vehicle comprises at least one coaxial rotor pair comprising a fixed-pitch rotor and a variable-pitch rotor, the fixed-pitch rotor and the variable-pitch rotor being axially spaced relative to one another on a rotor axis and axially aligned along said rotor axis for rotation, each of the fixed-pitch rotor and the variable-pitch rotor comprising a number of blades extending in a radial direction, and
wherein the actuator and pushrod are connected to blades of the variable pitch rotor.

24. The vehicle according to claim 10, wherein a diameter of the plurality of blades is constant, and wherein the controller is configured to vary the collective pitch of the plurality of blades to increase pitch angle of the plurality of blades at a constant thrust level.
